(19) United States
(12) Patent Application Publication
(10) Pub. No.: US 2007/0168694 A1
(43) Pub. Date: Jul. 19, 2007

(54) System and method for identifying and removing pestware using a secondary operating system

(76) Inventors: Phil Maddaloni, Erie, CO (US); Tony Nichols, Erie, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/334,316

(22) Filed: Jan. 18, 2006

(51) Int. Cl. G06F 11/00

(52) U.S. Cl. 714/4

(57) ABSTRACT

Systems and methods for detecting and managing pestware are described. In one variation, a secondary operating system operates simultaneously with a primary operating system of a computer, and an anti-pestware application or service utilizes the secondary operating system to scan for indicia of pestware-related activity that may adversely affect a primary operating system of the computer.

### RELATED APPLICATIONS

The present application is related to the following commonly owned and assigned applications: Ser. No. 10/956,578, Attorney Docket No. WEBR-002/00US, entitled System and Method for Monitoring Network Communications for Pestware; application Ser. No. 10/956,573, Attorney Docket No. WEBR-003/00US, entitled System and Method For Heuristic Analysis to Identify Pestware; application Ser. No. 10/956,574, Attorney Docket No. WEBR-005/00US, entitled System and Method for Pestware Detection and Removal; application Ser. No. 11/145,593, Attorney Docket No. WEBR-009, entitled System and Method for Neutralizing Locked Pestware Files; application Ser. No. 11/104,202, Attorney Docket No. WEBR-011/00US, entitled System and Method for Directly Accessing Data From a Data Storage Medium; application Ser. No. 11/105,978, Attorney Docket No. WEBR-013/00US, entitled System and Method for Scanning Obfuscated Files for Pestware; application Ser. No. 11/105,977, Attorney Docket No. WEBR-014/00US, entitled: System and Method for Scanning Memory for Pestware Offset Signatures; application Ser. No. 11/106,122, Attorney Docket No. WEBR-018/00US, entitled System and Method for Scanning Memory for Pestware; application Ser. No. 11/237,291 Attorney Docket No. WEBR-020/00US, entitled Client Side Exploit Tracking; application Ser. No. 11/145,592, Attorney Docket No. WEBR-024/00US, entitled System and Method for Analyzing Locked Files; application Ser. No. (unassigned), Attorney docket No. WEBR-029/00US, entitled System and Method for Neutralizing Pestware That is Loaded by a Desirable Process, and application Ser. No. (Unassigned), Attorney Docket No. WEBR-028/00US entitled System and Method for Managing Pestware Affecting an Operating System of a Computer, filed herewith, each of which is incorporated by reference in their entirety.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for managing pestware on a protected computer.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization, any “watcher processes” related to the pestware, and any software or file that disrupts system performance.

Software is available to detect some pestware, but many variations of pestware are difficult to detect with typical techniques. For example, pestware running in memory of a computer is often difficult to detect because it is disguised in such a way that it appears to be a legitimate process that is dependent from a trusted application (e.g., a word processor application). In other cases, pestware is obfuscated with encryption techniques so that a pestware file stored on a system hard drive may not be readily recognizable as a file that has spawned a pestware process. In yet other instances, pestware is known to be polymorphic in nature so as to change its size in memory or to change its starting address in memory. Still, in other instances, pestware renders a portion of a system inoperable thereby preventing an operating system or a pestware removal process from functioning properly. Accordingly, current software is not always able to identify and remove pestware in a convenient manner and will most certainly not be satisfactory in the future.

### SUMMARY OF THE INVENTION

Exemplary embodiments of the present invention are shown in the drawings and are summarized below. These and other embodiments are more fully described in the Detailed Description. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Embodiments of the present invention include methods, computer-readable mediums, and systems for managing pestware present in a protected computer or system. In one embodiment for example, the invention may be characterized as a method for managing pestware. The method in this embodiment includes utilizing a primary operating system to effectuate operations of a computer, running a secondary operating system simultaneously with the primary operating system, utilizing the secondary operating system to identify indicia of pestware-related activity on the computer and managing the pestware-related activity.

In another embodiment, the invention may be characterized as a pestware management system comprising a first anti-pestware module in communication with a primary operating system of a computer and a second anti-pestware module in communication with a secondary operating system of the computer. In this embodiment, the second anti-pestware module includes a detection module configured to identify pestware activity that adversely affects operation of the first anti-pestware module.

These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 is a block diagram depicting a protected computer in accordance with one implementation of the present invention;

FIG. 2 illustrates a flow chart for managing pestware, which may be utilized in connection with the protected computer depicted in FIG. 1;

FIG. 3 is a block diagram depicting a protected computer in accordance with another embodiment of the present invention;

FIG. 4 illustrates a flow chart for managing pestware, which may be utilized in connection with the protected computer depicted in FIG. 3; and

FIG. 5 is a block diagram depicting interaction between primary and secondary operating systems in accordance with an exemplary embodiment.

### DETAILED DESCRIPTION

In accordance with several embodiments, the present invention is directed to managing pestware utilizing an operating system that is secondary to a primary operating system of a computer. As described further herein, the primary operating system in several embodiments is an operating system that is utilized during ordinary day-to-day operations with the computer while the secondary operating system is utilized for purposes of managing pestware.

In other embodiments, however, the secondary operating system is not limited to pestware management and may be utilized in connection with other operations on the computer. As a consequence, as used herein, the term “secondary” is not to be interpreted to mean subordinate unless indicated otherwise. Instead, it should merely refer to a second operating system that is a separate operating system from the primary operating system.

As discussed further herein, in many embodiments the secondary operating system is utilized while the primary operating system is inactive. In this way, pestware that is designed to adversely affect the primary operating system, for example, may be more effectively managed with the secondary operating system. In some instances for example, pestware is known to impart hooks into the primary operating system of a computer, which controvert known methodologies (e.g., pestware scanning) to identify and remove the pestware. In these instances, the secondary operating system, which the pestware is not designed to interfere with, may be utilized to boot the computer while the primary operating system is inactive. In this way, pestware identification techniques (e.g., pestware scanning) may be effectively employed utilizing the secondary operating system.

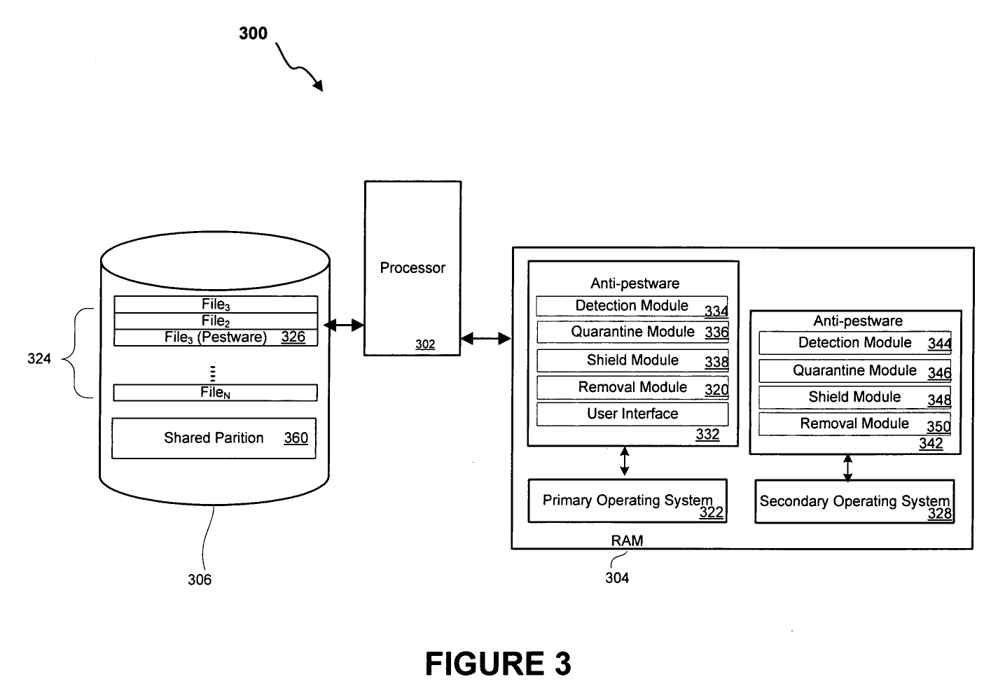

In other embodiments, as discussed further herein with reference to FIGS. 3-5, the secondary operating system is operated simultaneously with the primary operating system so as to enable enhanced pestware management while the primary operating system is operating. In these embodiments, an anti-pestware application or service utilizes the secondary operating system to carry out pestware identification, pestware prevention, pestware removal and/or pestware disablement. In this way, if pestware is interfering with normal operation of the primary operating system, the anti-pestware application or service is able to effectively carry out its functions using the secondary operating system.

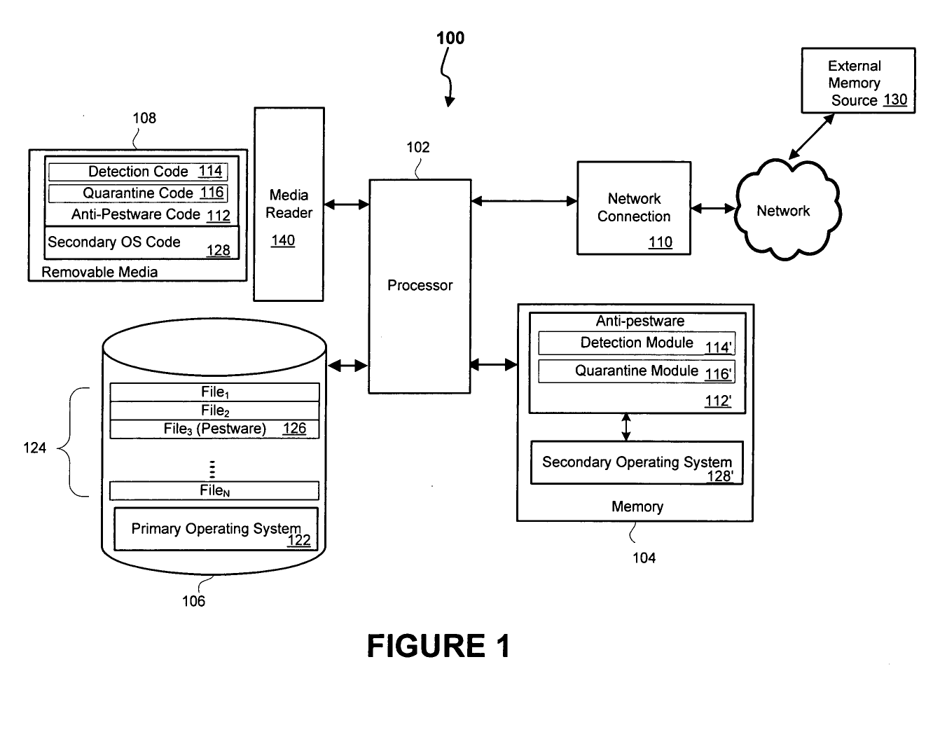

Referring first to FIG. 1, shown is a block diagram 100 of a protected computer/system 100 in accordance with one implementation of the present invention. The term “protected computer” and “computer” is used herein to refer to any type of computer system, including personal computers, handheld computers, servers, firewalls, etc. This implementation includes a processor 102 coupled to memory 104 (e.g., random access memory (RAM)), a file storage device 106, a media reader 140, and a network interface 110.

Also shown adjacent to the media reader 140 is a removable media 108, which includes code for a secondary operating system 128 and anti-pestware code 112, which includes pestware detection code 114 and quarantine code 116. The removable media 108 may be any one of a variety of storage mediums including optical (e.g., DVD or compact disc), flash memory (e.g., a USB flash memory device), or a floppy disc. Concomitantly, the media reader 140 may be an optical disk reader, flash memory reader or floppy drive.

As shown, the storage device 106 provides storage for a primary operating system 122 of the protected computer 100 and a collection of N files 124, which include a pestware file 126. The storage device 106 in several implementations is a hard disk drive, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be partitioned and/or may be realized by multiple (e.g., distributed) storage devices.

Except as indicated herein, the primary OS 122 is not limited to any particular type of operating system and may be operating systems provided by Microsoft Corp. under the trade name WINDOWS (e.g., WINDOWS 95, 98, 2000, NT and XP). Additionally, the primary OS 122 may be an open source operating system such operating systems distributed under the LINUX trade name. For convenience, however, embodiments of the present invention are generally described herein with relation to WINDOWS-based systems. In light of the teaching disclosed herein, those of skill in the art can adapt these implementations for other types of operating systems or computer systems.

In the exemplary embodiment depicted in FIG. 1, the protected computer 100 is shown in an exemplary state after the computer is booted with the secondary OS code 128 residing on the removable media 108. As shown, after booting the protected computer 100, a secondary operating system 128′ resides in memory 104 and the anti-pestware code 112 is also loaded and executed so that an anti-pestware module 112′ is operable in memory 104. As depicted in FIG. 1, the anti-pestware module 112′ includes a detection module 114′ and a quarantine module 116′.

In the exemplary embodiment, the secondary operating system 128′ is a small footprint operating system (OS). In this context, the term footprint refers to the amount of storage space required by the secondary operating system 128′. Accordingly, a small footprint OS refers to a small amount of storage space relative to the storage space occupied by the primary operating system 122. In one embodiment, the secondary operating system 128′ is a FreeDOS OS, and in another embodiment secondary operating system 128′ is a Linux OS. The secondary OS 128′ is not limited to any particular type of operating system and one of ordinary skill in the art will recognize that the secondary operating system may be realized by other types of operating systems including custom operating systems.

In the exemplary embodiment, the secondary operating system 128′ and the anti-pestware module 112′ are loaded from the secondary OS code 128 and the anti-pestware code 112, respectively, residing on the removable media 108, but this is certainly not required. In other embodiments, for example, the secondary OS code 128 and/or the anti-pestware code 112 may reside in the data storage device 106.

Placing the secondary OS code 128 on the removable media is especially beneficial in many instances, however, because this allows the protected computer 100 to be booted from the removable media 128, and as a consequence, any pestware that places hooks in the primary operating system 122 is circumvented. In other words, if the primary operating system 122 is infected, booting from the removable media allows the primary-infected operating system to be bypassed. In this way, the anti-pestware code 112 may then be launched without interference from pestware (e.g. the pestware file 126) that adversely affects the primary operating system 122.

As shown, the anti-pestware module 112′ includes a detection module 114′ and a quarantine module 116′, which are executed from the memory 104 by the processor 102. In addition, the secondary operating system (OS) 128′ is also depicted as running from memory 104. In this embodiment, the detection module 114′ is configured to scan files of the storage device 106 using pestware definitions so as to identify pestware (e.g., the pestware file 126) residing on the storage device 106. In addition, the detection module 114′ in his embodiment is configured to locate and parse registry and host files that are utilized by the primary operating system 122 (i.e., when the primary operating system is active) so as to identify any suspect entries that are indicia of potential pestware activity. Moreover, the detection module 114′ is configured to scan for pestware cookies residing on the storage device 106.

If any pestware files are identified by the detection module 114′, the quarantine module 116′ is configured to quarantine them (e.g., by compressing and encrypting the pestware file) and store the quarantined files on the storage device 106 for potential release from quarantine at a later time. The above-identified application entitled System and Method for Pestware Detection and Removal includes additional details about scanning for and quarantining pestware.

In many embodiments, the detection module 114′ and quarantine module 116′ directly access the storage device 106 (i.e., without using the secondary OS 128′) to scan the storage device 106 for pestware activity and quarantine any identified pestware. The above-identified application entitled System and Method for Directly Accessing Data From a Data Storage Medium details direct disk access techniques that may be utilized in connection with many embodiments of the present invention.

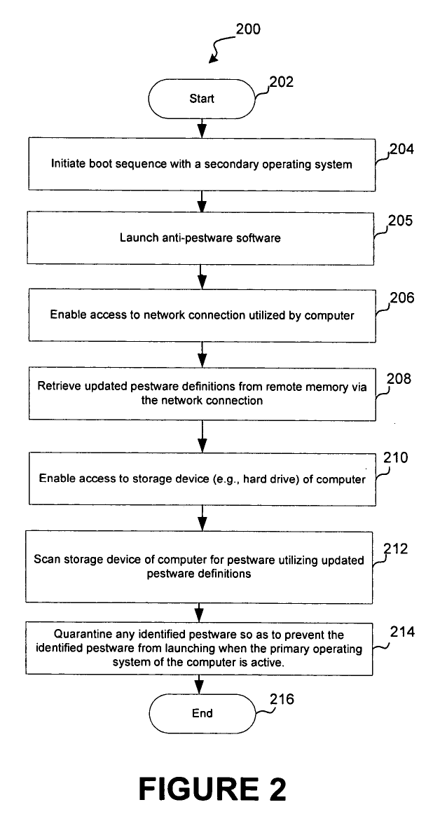

While referring to FIG. 1, simultaneous reference will be made to FIG. 2, which is a flowchart 200 depicting a method for managing pestware utilizing the secondary operating system 128′ depicted in FIG. 1. Although the method 200 depicted in FIG. 2 is described with reference to FIG. 1 for convenience, it should be recognized that the method 200 is certainly not limited to the embodiment described with reference to FIG. 1.

As shown in FIG. 2, initially the protected computer 100 is booted from the removable media 108 so as to initiate a boot sequence utilizing the secondary operating system code 128 (Blocks 202, 204). As discussed, in other embodiments the secondary operating system code 128 resides on a storage device (e.g., the storage device 106) of a protected computer. Once the secondary operating system 128′ is operational, the anti-pestware code 112 is accessed and launched so as to reside in memory 104 as the anti-pestware module 112′. In many embodiments, as depicted in FIG. 1, the anti-pestware code 112 resides on, and is accessed from, removable media. Although storing the anti-pestware code 112 on the removable medium 108 substantially reduces the likelihood of the code 112 being compromised by pestware, it is certainly not required, and in other embodiments the anti-pestware code 112 may reside on a storage device of the protected computer in advance of the protected computer being booted with the secondary operating system code 128.

As depicted in FIG. 2, in some embodiments the secondary operating system 128′ is configured to enable access to the network interface 110 of the protected computer 100 so as to allow updated pestware definitions and/or updated anti-pestware code to be retrieved from the external memory source 130 (Blocks 206, 208). In other variations, retrieving updated pestware definitions via a network connection may be unnecessary if, for example, updated definitions are on the removable media 108. In some instances, for example, updated definitions may be downloaded to the removable media 108 (e.g., utilizing another computer) just before placing the removable media 108 in the media reader 140 of the protected computer 100.

As shown in FIG. 2, in order to scan files that are utilized by the protected computer 100, access to one or more storage devices (e.g., the storage device 106) is enabled (Block 210). As discussed previously, in some embodiments the anti-pestware code 112 includes code enabling direct access to, and scanning of, the storage device 106. Although not required, directly accessing (i.e., circumventing the secondary operating system 128′) is beneficial in some instances where the secondary operating system 128′ is not well suited to locating specific files and/or specific information in the files.

For example, the secondary operating system 128′ may not be best suited for locating registry and host files that are utilized by the primary operating system 122. Moreover, as described in the above-identified application entitled System and Method for Directly Accessing Data From a Data Storage Medium, directly accessing the storage device 106 may substantially reduce the amount of time required to access files on the storage device 106.

As shown in FIG. 2, once access to the storage device is obtained (e.g., via direct access or via the secondary operating system 128′), the storage device storage 106 is scanned for pestware (Block 212), and if any pestware and/or suspected pestware is identified, then pestware files are quarantined (Block 214). In some embodiments, a user is informed of any pestware found on the protected computer 100 and given the option of whether or not to quarantine the file.

Referring next to FIG. 3, shown is a block diagram 300 of another embodiment of a protected computer/system 300. This implementation includes a processor 302 coupled to memory 304 (e.g., random access memory (RAM)) and a file storage device 306.

As shown, the storage device 306 provides storage utilized by both a primary operating system 322 and a secondary operating system 328 of the protected computer 300 and a collection of N files 324, which includes a pestware file 326. The storage device 306 in several implementations as a hard disk drive, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be partitioned and/or may be realized by multiple (e.g., distributed) storage devices.

Except as indicated herein, the primary OS 322 is not limited to any particular type of operating system and may be operating systems provided by Microsoft Corp. under the trade name WINDOWS (e.g., WINDOWS 95, 98, 2000, NT and XP). Additionally, the primary OS 322 may be an open source operating system such operating systems distributed under the LINUX trade name. For convenience, however, embodiments of the present invention are generally described herein with relation to WINDOWS-based systems. In light of the teaching disclosed herein, those of skill in the art can adapt these implementations for other types of operating systems or computer systems.

In the exemplary embodiment, the secondary operating system 328 is a small footprint operating system (OS), but this is certainly not required. In one embodiment, the secondary operating system 328 is a FreeDOS OS, and in another embodiment secondary operating system 328 is a Linux OS. The secondary OS 328 is not limited to any particular type of operating system and one of ordinary skill in the art will recognize that the secondary operating system may be realized by other types of operating systems including custom operating systems.

As shown in FIG. 3, in this embodiment a first anti-pestware module 332 and a second anti-pestware module 342 operate simultaneously to provide protection against pestware. As depicted, the first anti-pestware module 332 interfaces with the computer 300 utilizing the primary operating system 322 and the second anti-pestware module 342 interfaces with the computer 300 utilizing the secondary operating system 328.

In operation, the second anti-pestware module 342 runs in the background (from a perspective of a user) looking for indicia of pestware-related activity while the first-anti-pestware module 332 runs in the foreground utilizing the primary operating system 322. In the exemplary embodiment, the second anti-pestware module 342 communicates results of its pestware scanning to the first anti-pestware module 332 via the shared partition 360 on the storage device 306, which is accessible by both the first anti-pestware module 332 and the second anti-pestware module 342. The first anti-pestware module 332 then provides information about potential pestware activity to the user via the user interface 340.

As depicted in the exemplary embodiment, the user interface 340 utilizes the primary operating system 322 to provide an interface to the user. In another embodiment, the user interface 322 is realized by another software component that utilizes the secondary operating system 128. One of ordinary skill in the art having the benefit of this disclosure will recognize that the user interface may be realized in a variety of manners including, but not limited to, text-based and graphic-based user interfaces.

In one embodiment, a user may toggle (e.g., utilizing one or more keystrokes) between the user interface 340 of the first anti-pestware module 332 and a user interface (not shown) provided by the second anti-pestware module 342. In this way, if pestware interferes with the operation of the first anti-pestware module 332 to such an extent that the user interface 340 is adversely affected, the user may effectuate pestware scans by directly interfacing with the second anti-pestware module 342.

Advantageously, in the event pestware is adversely affecting the performance of the first anti-pestware module 332 (e.g., by placing hooks in the primary operating system 322), the second anti-pestware module 342 is able to continue to operate substantially unaffected by the pestware by virtue of interfacing with the computer 300 via the secondary operating system 328. In many embodiments, the second anti-pestware module 342 scans continuously, but in other embodiments the second anti-pestware module 342 scans at predetermined time intervals, when a predetermined event occurs, and/or in response to a user's direction.

As shown, the second anti-pestware module 342 in the exemplary embodiment of FIG. 3 is capable of carrying out the same anti-pestware-related functions that are carried out by the first anti-pestware module 332. In particular, the second anti-pestware module 342 includes a detection module 344, quarantine module 346, shield module 348 and removal module 350 that correspond to the detection module 334, quarantine module 336, shield module 338 and removal module 320 of the first anti-pestware module 332. This is certainly not required, however, and in other embodiments, the second anti-pestware module 342 provides only a subset of the anti-pestware functionality provided by the first anti-pestware module 332.

The detection module 344 for example, performs scans of the storage device 106 and memory 304 for indicia of pestware residing on the computer 300 so that the pestware may be quarantined by the quarantined module 346 and the removed by the removal module 350. The above-identified application entitled System and Method for Pestware Detection and Removal provides details relative to several detection and removal techniques. In addition, the above identified applications entitled System and Method for Neutralizing Locked Pestware Files, System and Method for Directly Accessing Data From a Data Storage Medium provide details for directly accessing the storage device 106 (e.g., to identify and remove pestware) while circumventing the operating systems 322, 328 of the computer.

Additional information related to scanning the storage device 106 and/or memory 304 of the computer are found in the above-identified applications entitled: System and Method for Scanning Obfuscated Files for Pestware; System and Method for Scanning Memory for Pestware Offset Signatures; System and Method for Scanning Memory for Pestware; and System and Method for Removing Pestware From System-Level Processes and Executable Memory.

Additional information related to various embodiments of shields implemented by the shield module 348 are found at the above identified applications entitled: System and Method for Pestware Detection and Removal; System and Method For Heuristic Analysis to Identify Pestware; and Client Side Exploit Tracking.

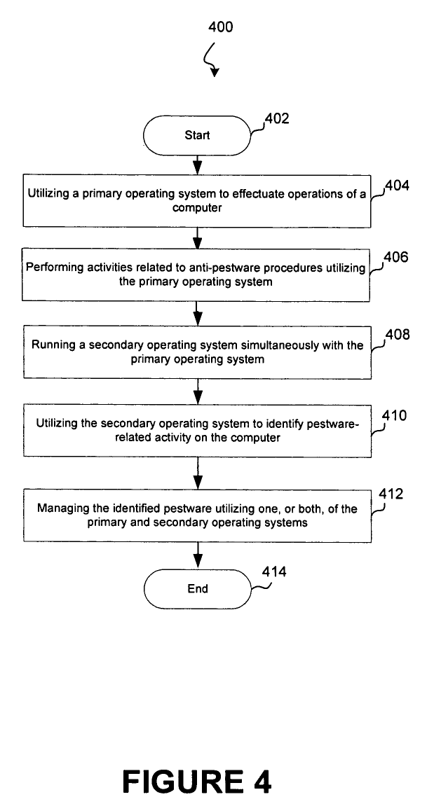

Referring next to FIG. 4, shown is a flowchart for managing pestware in accordance with an embodiment of the present invention. While referring to FIG. 4, simultaneous reference will be made to FIG. 3, but it should be recognized that the method depicted in FIG. 4 is certainly not limited to the specific embodiment described with reference to FIG. 3.

As shown, the primary operating system 322 in this method is utilized to effectuate general operations of the computer 300 (e.g., providing access to hardware of the computer) and the first anti-pestware module 332 utilizes the primary operating system 332 to perform activities related to anti-pestware procedures (e.g., pestware scanning, quarantining and pestware removal) (Blocks 402, 404, 406).

In addition, the secondary operating system 328 operates simultaneously with the primary operating system 322, and the second anti-pestware module 342 utilizes the secondary operating system 328 to identify pestware related activity on the computer 300 (Blocks 408, 410). The identified pestware activity is then managed utilizing one or more of the primary and secondary operating systems 332, 342 (Block 412).

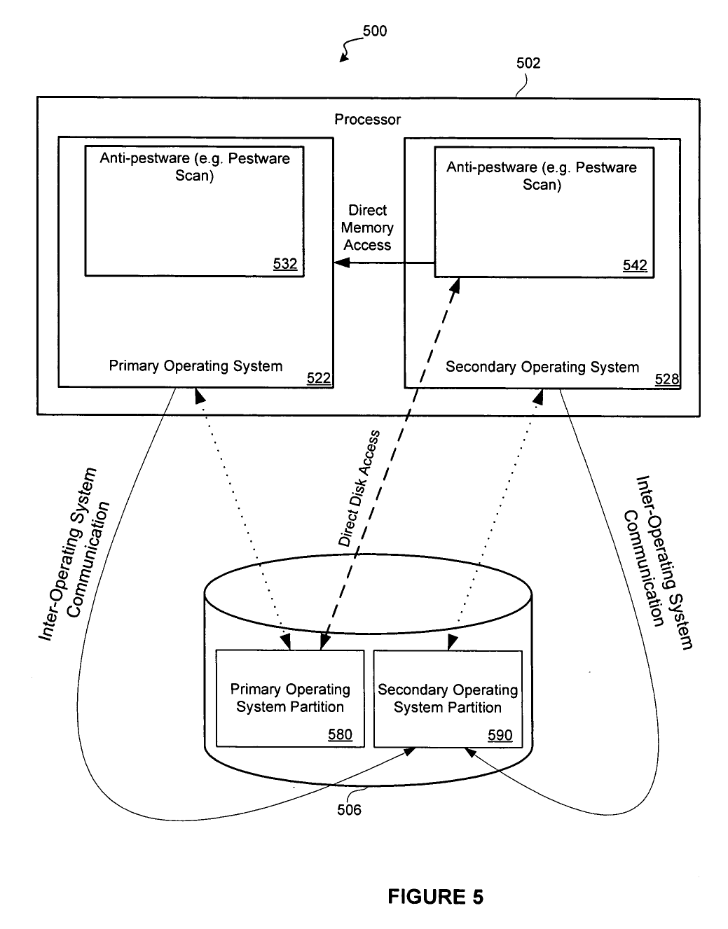

Referring next to FIG. 5, shown is a block diagram of a computer 500, which depicts interaction between primary and secondary operating systems in accordance with an exemplary embodiment. As shown, primary and secondary operating systems 522, 528 in this embodiment provide an interface to a processor 502 for first and second anti-pestware modules 532, 542.

As depicted, associated with the primary and secondary operating systems 522, 528 are primary and secondary operating system partitions 580, 590 on a storage device 506 (e.g., disk drive). In this embodiment, the primary and secondary operating systems 522, 528, and hence, the first and second anti-pestware modules 532, 542 communicate via the secondary operating system partition 590 by storing and accessing information in the secondary operating system partition.

As depicted in FIG. 5, the second anti-pestware module 542 in this embodiment is also configured to directly access (e.g., to scan for pestware while circumventing the operating systems 522, 528) both, memory utilized by the primary operating system 522 and the primary operating system partition 580 of the storage device 506.

In conclusion, the present invention provides, among other things, a system and method for managing pestware. Those skilled in the art can readily recognize that numerous variations and substitutions may be made in the invention, its use and its configuration to achieve substantially the same results as achieved by the embodiments described herein. Additional advantages of embodiments of the present invention include restoring portions of the primary operating system (e.g., when a boot record is damaged). In these embodiments, the user may be provided with an option to replace a damaged boot record with backup boot record, if one is found.

What is claimed is:

1. A method for managing pestware comprising:
utilizing a primary operating system to effectuate operations of a computer;
running a secondary operating system simultaneously with the primary operating system;
utilizing the secondary operating system to identify indicia of pestware-related activity on the computer; and
managing the pestware-related activity.

2. The method of claim 1, wherein the operations of the computer effectuated with the primary operating system include operations visible to a user of the computer.

3. The method of claim 1 including:
informing, utilizing the primary operating system, a user about the pestware-related activity on the computer.

4. The method of claim 3 including:
storing information about the identified pestware-related activity on a storage media accessible by the primary operating system;
accessing the information utilizing the primary operating system; and
displaying at least a portion of the information for a user.

5. The method of claim 4, wherein the managing the pestware includes a user providing direction relative to management of the pestware based on the at least a portion of the information.

6. The method of claim 1, wherein the utilizing the secondary operating system to identify indicia of pestware activity on the computer includes running pestware identification code utilizing the secondary operating system.

7. The method of claim 6, wherein the pestware identification code includes code to scan both, an executable memory and a storage device of the computer.

8. The method of claim 7, wherein the pestware detection code includes code to circumvent the secondary operating system when scanning the executable memory and the storage device of the computer.

9. The method of claim 6, wherein the pestware identification code includes a driver in communication with the secondary operating system to identify indicia of pestware activity.

10. The method of claim 1, wherein the managing includes managing the pestware-related activity utilizing a management scheme selected from the group consisting of: quarantining pestware; removing the pestware and disabling the pestware.

10. A pestware management system comprising:
a first anti-pestware module in communication with a primary operating system of a computer; and
a second anti-pestware module in communication with a secondary operating system of the computer, and wherein the second anti-pestware module includes a detection module configured to identify pestware activity that adversely affects operation of the first anti-pestware module.

11. The pestware management system of claim 10, wherein the second anti-pestware module is configured to communicate with the first anti-pestware module so as to enable the second anti-pestware module to provide information about the potential pestware activity to the first anti-pestware module.

12. The pestware management system of claim 10, wherein the second anti-pestware module includes a quarantine module configured to quarantine a file identified as a potential pestware file.

13. The pestware management system of claim 10, wherein the detection module of the second anti-pestware module is configured to scan an executable memory of the computer so as to identify indicia of pestware activity on the computer.

14. The pestware management system of claim 13, wherein the detection module is configured to scan the executable memory by selectively scanning portions of memory for indicia of pestware activity that are offset from reference points in the executable memory.

15. The pestware management system of claim 14, wherein the reference points include reference points selected from the group consisting of: an API implementation and a start address of a process.

16. The pestware management system of claim 14, wherein the detection module is configured to scan executable op code at the portions of the memory for the indicia of pestware activity.
